(19) United States
(12) Patent Application Publication
(10) Pub. No.: US 2025/0165724 A1
(43) Pub. Date: May 22, 2025

(54) CYBER SECURITY SYSTEM FOR ELECTRONIC COMMUNICATIONS

(71) Applicant: Nathan Bryce MCINTYRE, Plano, TX (US)

(72) Inventor: Nathan Bryce MCINTYRE, Plano, TX (US)

(21) Appl. No.: 18/954,194

(22) Filed: Nov. 20, 2024

Related U.S. Application Data
(60) Provisional application No. 63/601,186, filed on Nov. 20, 2023.

(51) Int. Cl. G06F 40/47; H04L 51/063

(52) U.S. Cl. CPC G06F 40/47; H04L 51/063

(57) ABSTRACT

A method including receiving an electronic communication including content. The method also includes identifying, in the content, relevant data including a first portion of the content predetermined to be relevant to an evaluation of authenticity of the electronic communication and irrelevant data including a second portion of the content predetermined to be irrelevant to the evaluation. The method also includes converting the relevant data into a prompt for a language model. The method also includes executing the language model on the prompt. The method also includes outputting, by the language model, a prediction whether the electronic communication is at least one of malicious, deceptive, inauthentic, and untrustworthy.

### CROSS-REFERENCE TO RELATED APPLICATIONS

This application claims priority to U.S. Provisional Patent Application No. 63/601,186, filed Nov. 20, 2023, the entirety of which is hereby incorporated by reference.

### BACKGROUND

A large number of malicious, deceptive, inauthentic, or untrustworthy electronic communications (e.g., emails, instant messages, social media posts, etc.) evade cyber security systems designed to intercept the malicious, deceptive, inauthentic, or untrustworthy electronic communications. For example, malicious, deceptive, inauthentic, or untrustworthy emails may appear legitimate on the surface, or may be specifically designed to evade known cyber security procedures.

The malicious, deceptive, inauthentic, or untrustworthy nature of such electronic communications may be difficult to detect, both for the cyber security systems and for any humans that read the malicious, deceptive, inauthentic, or untrustworthy electronic communications. Thus, otherwise technically sophisticated users may still become victimized by cyber criminals.

### SUMMARY

One or more embodiments provide for a method. The method includes receiving an electronic communication including content. The method also includes identifying, in the content, relevant data including a first portion of the content predetermined to be relevant to an evaluation of authenticity of the electronic communication and irrelevant data including a second portion of the content predetermined to be irrelevant to the evaluation. The method also includes converting the relevant data into a prompt for a language model. The method also includes executing the language model on the prompt. The method also includes outputting, by the language model, a prediction whether the electronic communication is at least one of malicious, deceptive, inauthentic, or untrustworthy.

One or more embodiments also provide for a system. The system includes a computer processor and a data repository in communication with the computer processor. The data repository stores an electronic communication including content. The content includes relevant data including a first portion of the content predetermined to be relevant to an evaluation of authenticity of the electronic communication and irrelevant data including a second portion of the content predetermined to be irrelevant to the evaluation. The data repository also stores a prompt for a language model. The data repository also stores a prediction whether the electronic communication is at least one of malicious, deceptive, inauthentic, or untrustworthy. The system also includes a server controller which, when executed by the computer processor, performs a computer-implemented method. The computer-implemented method includes receiving the electronic communication. The computer-implemented method also includes identifying, in the content, the relevant data and the irrelevant data. The computer-implemented method also includes converting the relevant data into a prompt for a language model. The computer-implemented method also includes executing the language model on the prompt. The computer-implemented method also includes outputting, by the language model, the prediction.

Other aspects of one or more embodiments will be apparent from the following description and the appended claims.

### BRIEF DESCRIPTION OF DRAWINGS

FIG. 1A and FIG. 1B shows a computing system, in accordance with one or more embodiments.

FIG. 2 shows a flowchart of a cybersecurity method, in accordance with one or more embodiments.

FIG. 3A, FIG. 3B, and FIG. 3C show a data flow diagram, in accordance with one or more embodiments.

FIG. 4A, FIG. 4B, FIG. 4C, and FIG. 4D show screenshots of one or more embodiments operating with respect to a received email, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to mitigating malicious, deceptive, inauthentic, or untrustworthy electronic communications that may be undetected by existing cyber security systems or that circumvent existing cyber security systems. Malicious, deceptive, inauthentic, or untrustworthy electronic communications that are difficult to detect may be referred to as deceptively legitimate communications. The technical problem, then, is how to detect or mitigate deceptively legitimate communications.

One or more embodiments address the above described technical problem by using a language model to analyze the intent of an electronic communication and then to predict a likelihood that the electronic communication is malicious, deceptive, inauthentic, or untrustworthy. One or more embodiments may present an icon or button to the user. When selected, the button triggers the evaluation process for a currently selected electronic communication. However, the process may be automatically triggered, such as upon receipt of an email. While the application of one or more embodiments evaluates the electronic communication, the method can apply to other data sources and use cases in order to establish a credibility assessment for the underlying data.

One or more embodiments address another technical problem. Specifically, the other technical problem is that by themselves, language models are not suitable for simply inputting the content of the electronic communication into the language model in order to perform the desired security analysis. Technical challenges exist to permit a language model to provide a meaningful prediction of the maliciousness, deceptiveness, untrustworthiness, or legitimacy of the electronic communication. For example, language models can be prone to loss of context fidelity and also may be subject to limited context windows. In either case, the language models may exhibit a lack of clear direction. Thus, the language models may generate superficial results that fail to reflect metacognitive analysis. Accordingly, without more, language models are unsuitable for use in cybersecurity systems for electronic communications.

A brief summary of the technical solution to the problem of programming language models to detect deceptively legitimate communications is now presented. Initially, source data from the electronic communication and any additional data related to the electronic communication is processed to remove irrelevant data and to encode relevant data in a structured way. A structured data structure is thereby generated. The structured data then may be selectively included in one or more evaluation prompts or may be more accurately referenced in a complex prompt.

The structured data structure may include the set of tagged or classified data relevant to an evaluation. The structured data structure may be determined through optimization of elements used to submit each prompt for evaluation. Optimization may include data and metadata derived from the evaluation subject data source directly. The data and metadata may be generated in response to inputs including the data source or elements of the data source (e.g., labels, responses to previous prompts, or earlier instances of recursion), or may be generated in response to inputs including contextual data otherwise supplied, and or may be generated in response to inputs including relevant original data.

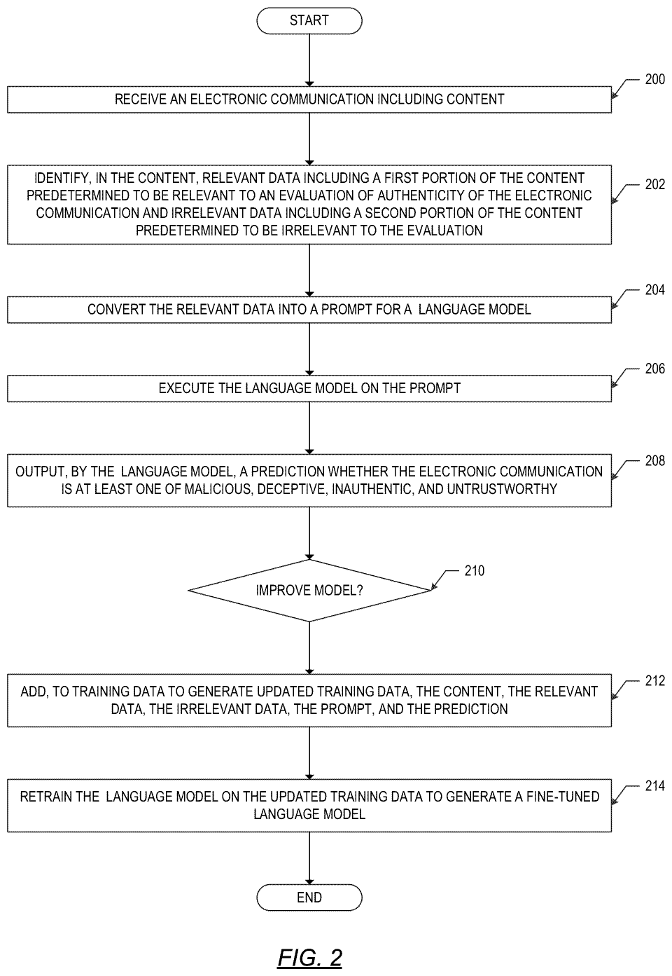

Processing of the structure data structure can be achieved by stochastic or deterministic methods, or by incorporation of both, but processing should result in the removal of data that is not useful in the evaluation, as described with respect to step 202 of FIG. 2. While language models may be competent to handle unstructured data successfully, the structure data structure is used to enforce evaluative focus, remove distracting elements, and reduce the overall length of inputs and outputs which are a significant concern for cost and performance of execution of the language model. The chosen shape of the inputs should model, as consistent and complete, a set of values to aid in achieving an accurate evaluation.

Such cleanup can reduce embedding noise, force the language model to avoid operating on irrelevant data elements, and force compliance with a predetermined context window size The paring of unrequired data could reduce both memory requirements and processing, though in the context of one or more embodiments, additional memory utilization may be of minimal concern. In some embodiments, model architecture may imply that processing requirements are correlated directly with token count. Thus, reduction of overall input size and concise specification of output format can meaningfully impact resource utilization.

The procedure of one or more embodiments can provide for more precise analysis with higher accuracy, and allows for more relevant data to be included within the language model context window. The procedure also provides for division of tasks for improved evaluation reliability and detail sensitivity.

The term “content,” with respect to electronic communications, includes text, images, and formatting that may be contained within the electronic communication (e.g., email, social media post, private message, etc.) While some language models may not be able to process images and formatting directly, metadata may be generated from the images and formatting. The metadata then may be added to the text in the electronic communication when generating a prompt to a language model. Additionally, a visual encoder machine learning model may be used to generate text (e.g., a caption) describing an image or describing the formatting of the electronic communication. In this case, the output text of the visual encoder may be added to the text in the electronic communication when generating the prompt to the language model. Thus, one or more embodiments contemplate that more than just text may be taken into consideration by the language model when predicting whether an electronic communication is malicious, deceptive, inauthentic, or untrustworthy.

The data may be sourced from the content to be evaluated and from other data sets that provide context for an evaluation. To provide access to aspects of elements that may not be explicit or available to a language model in an original data format, one or more embodiments process relevant elements to extract characteristics to be used in evaluation prior to encoding. Text content may be largely retained or summarized, although certain classifications of content might be removed, either for privacy or optimization. Link protection encoding may be removed and link parameters may be included along with additional link data derived from a database, live data, or other sources. Text may be extracted from media content and classification and description parameters identified and included. Attachments or other data may be similarly processed to extract data in a form usable by the model employed.

In the case of most content types, the position of elements such as links and media in the original content body is contextually relevant, so these data types are encoded in such a way that they can be referenced in context, either by inclusion of encoded sub-elements within the content element or with reference identifiers.

Thus, as described above, one or more embodiments provide one or more technical improvements to a language model. The technical improvements permit a language model to be used as a cybersecurity system for electronic communications.

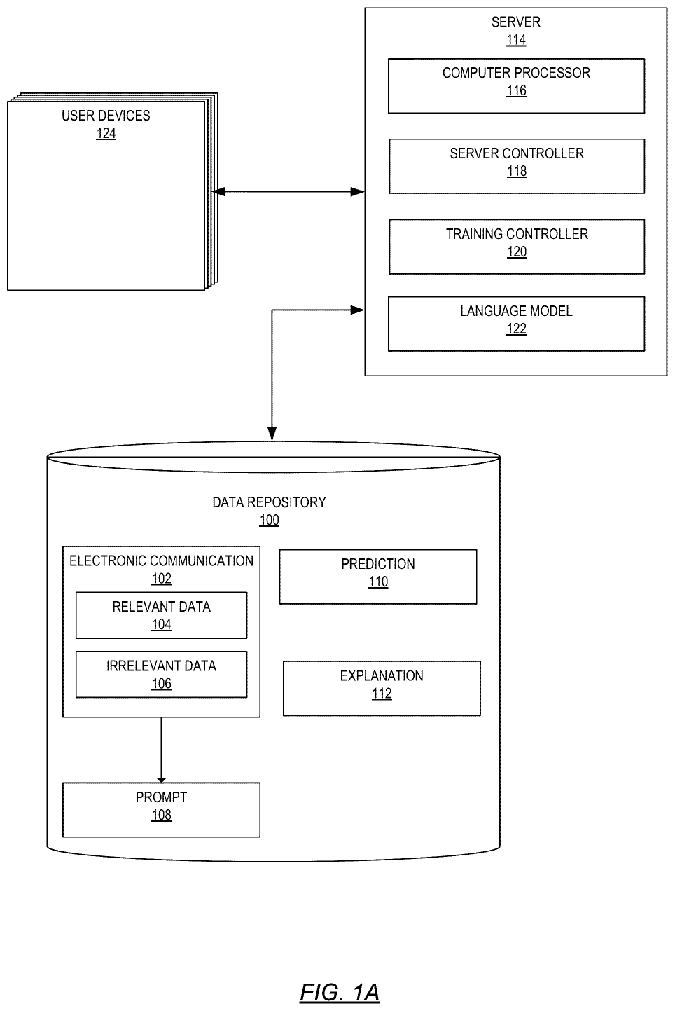

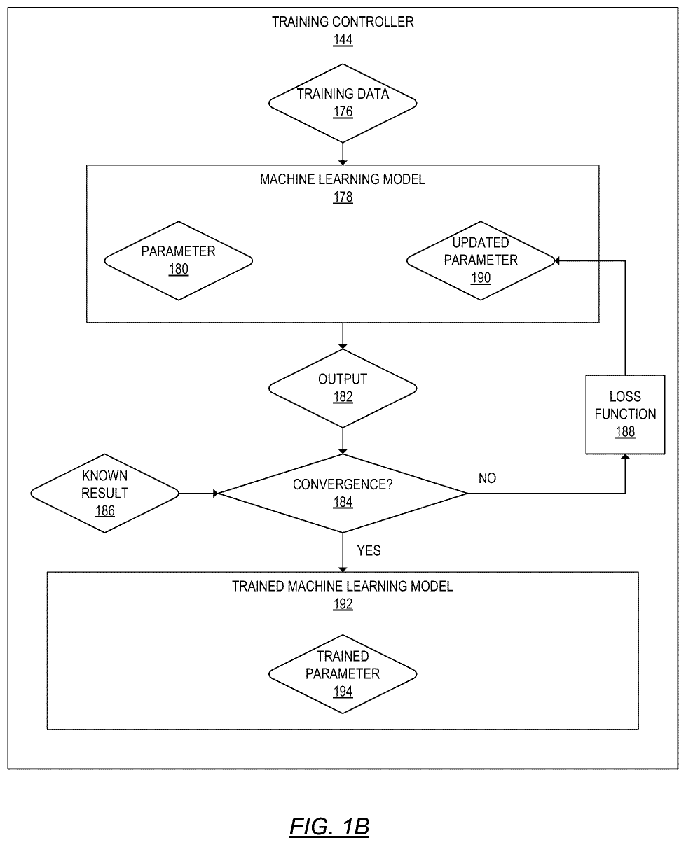

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores an electronic communication (102). The electronic communication (102) is an electronic message transmitted from a sending computing device to another computing device. The electronic communication (102) may be, for example, an email, a video file, an image file, a text message, an instant message, a social media post, an incoming data stream, digital assets, etc.

Generally, the electronic communication (102) is composed of content. The content includes one or more data elements (e.g., text information, a video data file, an image data file, etc.) that forms the subject or the message of the electronic communication. The content also may include routing information (e.g., an internet protocol address, a sender's email address, a short message service address, etc.) that was used to route the electronic communication. Additionally, in some embodiments, the content may include additional data related to the electronic communication (102) (e.g., metadata such as a timestamp, system data, historical data, heuristic data, trend data, and combinations thereof.)

The electronic communication (102) may contain relevant data (104) and irrelevant data (106). The relevant data (104) is a portion of the content that is predetermined to be relevant to an evaluation of authenticity of the electronic communication (102). The term “relevant,” with respect to the term “data,” means that a predetermination has been made that the data is pertinent to the determination of the authenticity of the electronic communication (102). The identification of the relevant data (104) in the electronic communication (102) is described with respect to FIG. 2.

The definition of the relevant data (104) may be expressed in the form of examples or rules. An example is a data type (e.g., a subject line of an email). A rule may be an executable file that analyzes the electronic communication (102) and determines according to the policies in the rule which data elements of the electronic communication (102) are relevant. Examples of the relevant data (104) may include the main body of an electronic communication (102) (e.g., message text, video content, image content, sender email address, etc.) or derived information (e.g., a caption for an image as generated by a vision machine learning model, system data, historical data, heuristic data, trend data, etc.)

In contrast, the irrelevant data (106) is another portion of the content predetermined to be irrelevant to the evaluation of authenticity of the electronic communication (102). The term “irrelevant,” with respect to the term “data,” means that a predetermination has been made that the data is not relevant to the determination of the authenticity of the electronic communication (102). The identification of the irrelevant data (106) in the electronic communication (102) is described with respect to FIG. 2.

The definition of the irrelevant data (106) may be expressed in the form of examples or rules. An example is a data type (e.g., a the recipient's email address). A rule may be an executable file that analyzes the electronic communication (102) and determines according to the policies in the rule which data elements of the electronic communication (102) are irrelevant. Examples of the irrelevant data (106) may include information contained within the electronic communication (102) (e.g., hypertext markup language (HTML) codes, metadata, data predetermined to be irrelevant, etc.) or derived information (e.g., after application of a rule, a portion of the electronic communication (102) that otherwise may be considered part of the relevant data (104) may instead be determined to be irrelevant data (106)).

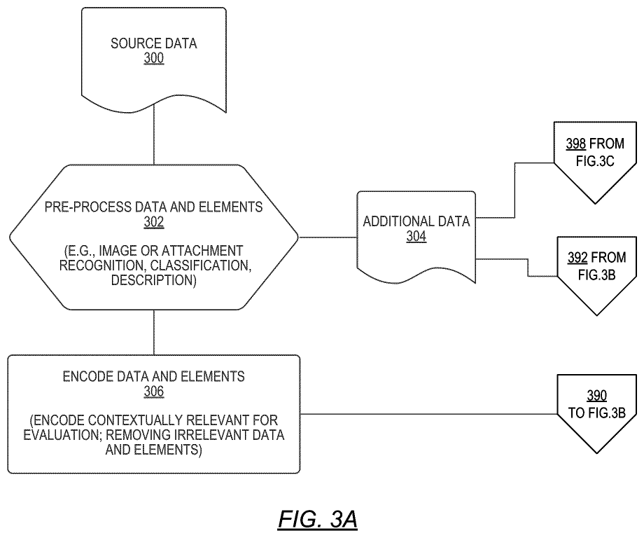

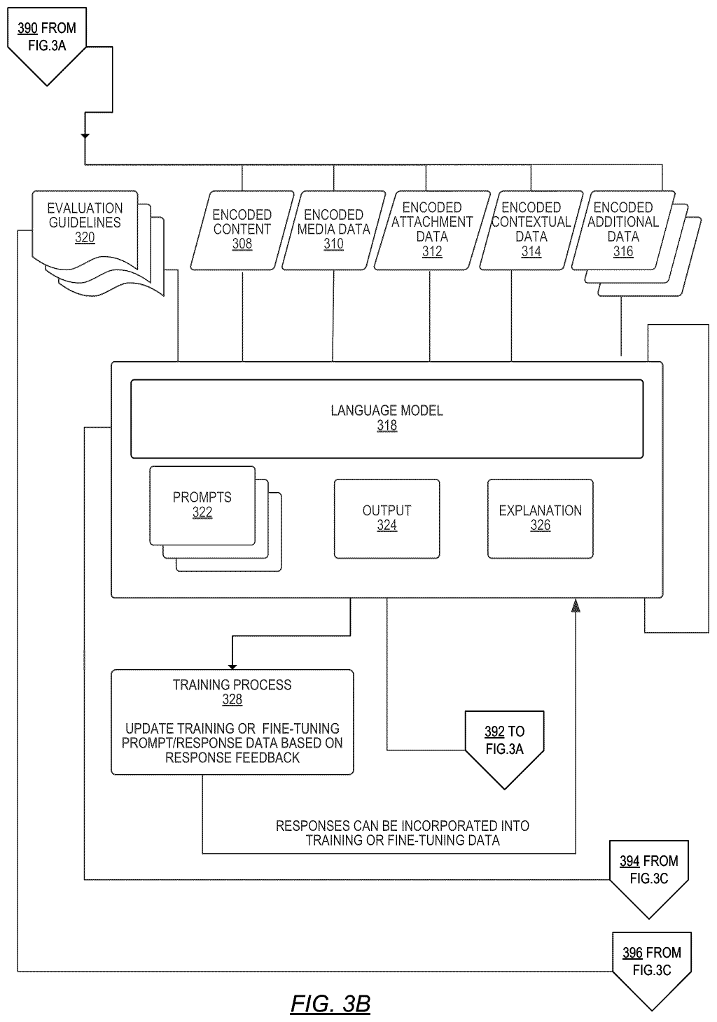

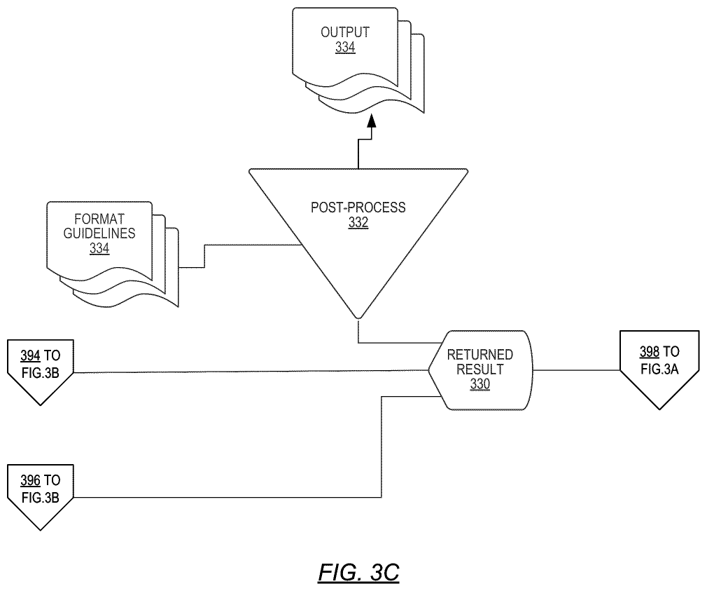

The data repository (100) also may store a prompt (108). The prompt (108) is instructions to a language model, expressed in text or in a structured language data structure. The language model (122), defined below, may execute on the prompt (108) in order to generate the prediction (110) (described below). Examples of the prompt (108) are provided with respect to FIG. 3B.

The data repository (100) also may store a prediction (110). The prediction (110) is an output of the language model (122). The prediction (110) is natural language text that indicates a prediction of whether the electronic communication (102) is at least one of malicious, deceptive, inauthentic, or untrustworthy. Alternatively, the prediction may be that the electronic communication (102) is at least one of benign, truthful, authentic, or trustworthy.

For example, the prediction (110) may not directly relate to malicious intent, and instead could be an evaluation of authenticity. Predictions may be part of a prompt-prediction chain of one more language models (e.g., the language model (122)) in which component or metacognitive analysis is performed. Such a flow feeds initial predictions as data elements in later prompts, thereby leading to the end result (i.e., the prediction (110)).

The term “malicious” means that the electronic communication (102) is predicted by the language model (122) to be knowingly designed, by a sending user, to cause harm to the receiving user in some manner. The term “deceptive” means that the electronic communication (102) is predicted by the language model (122) to be knowingly or unknowingly designed, by the sending user, to deceive the receiving user in some manner. The term “inauthentic” means that the electronic communication (102) is predicted by the language model (122) to be knowingly or unknowingly designed, by the sending user, to be an illegitimate representation of an authentic symbol or representation. The term “untrustworthy” means that the electronic communication (102) is predicted by the language model (122) to be, for whatever reason determined by the language model (122), suspicious and not to be trusted by the receiving user. A electronic communication (102) that is one or more of malicious, deceptive, inauthentic, or untrustworthy may be referred to as “illegitimate.”

The term “benign” means that the electronic communication (102) is predicted by the language model (122) not to contain elements or code that may cause harm to the receiving user. The term “truthful” means that the electronic communication (102) is predicted by the language model (122) to contain accurate information. The term “authentic” means that the electronic communication (102) is predicted by the language model (122) to be sent from the same sending user that the identity of the sending user specified in the electronic communication (102), and that the sending user is known and legitimate. The term “trustworthy” means that the electronic communication (102) is predicted by the language model (122) to be worthy of trust by the receiving user. A electronic communication (102) that is one or more of benign, truthful, authentic, or trustworthy may be referred to as “legitimate.”

Generation of the prediction (110) is described further with respect to FIG. 2 through FIG. 3C. Briefly, the prediction is generated by executing the language model (122) with the prompt (108).

The data repository (100) also stores an explanation (112). The explanation (112) is also an output of the language model (122). However, the explanation (112) is natural language text that describes why the language model generated the prediction (110). In other words, the language model (122), by way of the commands in the prompt (108), generates not only the prediction (110), but also the explanation (112) for the prediction (110). Generation of the explanation (112) is described further with respect to FIG. 2 through FIG. 3C.

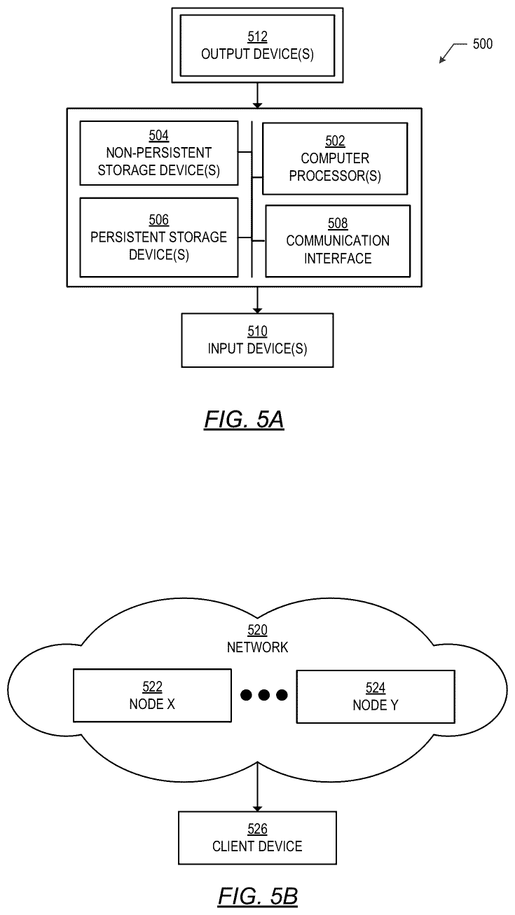

The system shown in FIG. 1A may include other components. For example, the system shown in FIG. 1A also may include a server (114). The server (114) is one or more computer processors, data repositories, communication devices, and supporting hardware and software. The server (114) may be in a distributed computing environment. The server (114) is configured to execute one or more applications, such as the server controller (118), the training controller (120), and the language model (122). An example of a computer system and network that may form the server (114) is described with respect to FIG. 5A and FIG. 5B.

The server (114) includes a computer processor (116). The computer processor (116) is one or more hardware or virtual processors which may execute computer readable program code that defines one or more applications, such as the server controller (118), the training controller (120), and the language model (122). An example of the computer processor (116) is described with respect to the computer processor(s) (502) of FIG. 5A.

The server (114) also may include a server controller (118). The server controller (118) is software or application specific hardware which, when executed by the computer processor (114), controls and coordinates operation of the software or application specific hardware described herein. Thus, the sever controller (118) may control and coordinate execution of the training controller (120) and the language model (122). The second data structure (118) also may include program code that, when executed by the computer processor (116), automatically generates one or more prompts, as described with respect to step 204 of FIG. 2.

The server (114) also may include a training controller (120). The training controller (120) is software or application specific hardware which, when executed by the computer processor (116), trains one or more machine learning models (e.g., the language model (122)). The training controller (120) is described in more detail with respect to FIG. 1B.

The server (114) also includes a language model (122). The language model (122) is a natural language processing machine learning model. In one embodiment, the language model (122) may be a large language model. A “large” language model is a model that has been trained on an amount of language data that a computer scientist may deem “large” (e.g., billions, trillions, or more of words and phrases) and that has a “large” number of parameters (e.g., billions, trillions, or more parameters). A parameter is a tunable value or set of values of a machine learning model (e.g., the language model (122)) which, when altered, changes an output of the machine learning model. One example of a large language model is (122) CHATGPT®.

One or more embodiments contemplate that, in many cases, the language model (122) is a large language model, due to the performance advantages that a large language model offers in certain electronic communication cyber security systems. However, the language model (122) may be one of a variety of different types of language models in different applications, or may be represented by an ensemble of language models. For example, the language model (122) may be a multimodal language model, a “small” language model (i.e., non-large language model), and other types of language models. The language model (122) also may be, as mentioned above, an ensemble of language models in which one of the outputs of the ensemble is selected, or the output is some combination of the outputs of the ensemble.

Use of the language model (122) is described with respect to FIG. 2. However, briefly, the language model (122) generates both the prediction (110) and the explanation (112) described above.

The system shown in FIG. 1A also may include one or more user devices (124). The user devices (124) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (124) are computing systems (e.g., the computing system (500) shown in FIG. 5A) that communicate with the server (122). A local user device may be used to manipulate various aspects of the sever (114). For example, in another embodiment, one or more of the user devices (124) may be operated by a computer technician that services the various components of the system shown in FIG. 1A.

In an embodiment, the user devices (124) may have separate language models executed individually by the user devices (124). In other words, in an embodiment, the language model (122) may be embodied in and executed by one or more of the user devices (124). In this case, the method of FIG. 2 or the training procedure of FIG. 1B may be executed directly on the user devices (124), rather than by the server (114). In any case, the user devices (130) are computing systems (e.g., the computing system (500) shown in FIG. 5A) that communicate with the server (114).

Attention is turned to FIG. 1B, which shows the details of the training controller (144). The training controller (144) is a training algorithm, implemented as software or application specific hardware, that may be used to train one or more machine learning models described with respect to the computing system of FIG. 1A.

In general, machine learning models, including the language model (122), are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to training data (176) in order to make predictions.

In more detail, training starts with the training data (176). The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of machine learning model being used (supervised versus unsupervised machine learning) or may be predetermined by a user (e.g., convergence occurs after a set number of training iterations, described below).

In the case of supervised machine learning, the convergence process (184) compares the output (182) to a known result (186). The known result (186) is stored in the form of labels for the training data. For example, the known result for a particular entry in an output vector of the machine learning model may be a known value, and that known value is a label that is associated with the training data.

A determination is made whether the output (182) matches the known result (186) to a predetermined degree. The predetermined degree may be an exact match, a match to within a pre-specified percentage, or some other metric for evaluating how closely the output (182) matches the known result (186). Convergence occurs when the known result (186) matches the output (182) to within the predetermined degree.

In the case of unsupervised machine learning, the convergence process (184) may be to compare the output (182) to a prior output in order to determine a degree to which the current output changed relative to the immediately prior output or to the original output. Once the degree of change fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a schema which attempts to guess how the parameter (180) may be changed so that the next execution of the machine learning model (178) using the training data (176) with the updated parameter (190) will have an output (182) that is more likely to result in convergence. For example, the next execution of the machine learning model (178) is more likely to match the known result (186) (supervised learning), or which is more likely to result in an output that more closely approximates the prior output (one unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data for which the final result is not known. The output of the trained machine learning model (192) is then treated as a prediction of the information of interest relative to the unknown data.

While FIG. 1A and FIG. 1B shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for cyber security for electronic communications, in accordance with one or more embodiments. The method shown may be executed using the system shown in FIG. 1.

Step 200 includes receiving an electronic communication including content. The electronic communication may be received by a number of methods at a target computing system from a source computing system. For example, receiving the electronic communication may include receiving at least one of an email, a text, an instant message, and a social media post. The electronic communication may be received at a server (i.e., the method of FIG. 2 is performed on a server), or may be received at a user device (i.e., the method of FIG. 2 is performed on a user device), or a combination thereof.

In an embodiment, identifying (step 202, below), converting (step 204, below), and outputting (step 208, below), and other steps may be performed automatically upon receipt of the electronic communication. Alternatively, the remaining steps of the method of FIG. 2 may be performed in response to a user command to analyze the electronic communication after receipt.

Step 202 includes identifying, in the content, relevant data including a first portion of the content predetermined to be relevant to an evaluation of authenticity of the electronic communication and irrelevant data including a second portion of the content predetermined to be irrelevant to the evaluation. Identifying the relevant data and irrelevant data may be performed by a number of different methods, which may be non-exclusive and may be combined.

For example, the content of the electronic communication may be compared to predetermined data types. Instances of data types in the electronic communication that match a category of “relevant data” are deemed to be the relevant data. Similarly, instances of other data types in the electronic communication that match a category of “irrelevant data” are deemed to be the irrelevant data.

In another example, a rule, policy, or machine learning model may be applied to the content of the electronic communication. The output of the rule, policy, or machine learning model may be a determination that any given instance of data within the electronic communication is relevant data or irrelevant data.

For example, a rule may state that any text in the body of the electronic communication is relevant data, and such text may be extracted for use in step 204, below. In another example, a policy may indicate that any images in the body of the electronic communication should be applied to a vision machine learning model to generate a caption, and if the caption matches a category of data deemed to be relevant, then the image, the caption, or both is relevant data to be extracted for use in step 204, below. In yet another example, a rule or policy may indicate that any hypertext markup language coding is irrelevant data. In the example, either such hypertext markup language data is discarded from further use in the method of FIG. 2, or the hypertext markup language data is ignored during further steps in the method of FIG. 2.

Thus, continuing the examples above, the content may include a combination of text, an image, and hypertext markup language (HTML) data. In this case, the relevant data may include the text and the image. However, the text may further include unimportant text determined, by a language model (e.g., the language model used at step 206), to be semantically unimportant. In this case, the irrelevant data includes the HTML data and the unimportant text. Other examples are possible.

Removing irrelevant data may be considered a form of noise reduction. Noise reduction in one or more embodiments refers to the exclusion of data that cannot or will not be employed in determining authenticity, the distillation of element data guided by a heuristic algorithm (e.g., the language model), or the application of refinement or normalization methods on data to be evaluated. In a simple example, hypertext markup language (HTML) elements might be removed that have no bearing over aspects of an email to be assessed. While the removed markup may be well understood and discounted by the language model when prompted appropriately, removal of semantically unimportant content generally provides better efficiency and result quality, as well as reduces content length. Content length may be a technical issue with some language models, due to limitations imposed by cost or context size constraints. In another case, similar HTML elements might be parsed and re-encoded to preserve some part of them that might contribute to an evaluation.

Step 204 includes converting the relevant data into a prompt for a language model. Converting the relevant data into a prompt may be performed according to a number of different techniques.

For example, when the relevant data includes text, the text may be directly inserted into the prompt. The text also may be inserted into a prompt template that includes additional commands to the language model.

In another example, when the relevant data includes multiple different data types, each different data type (or selected ones of the data types) may be sorted into different prompts drawn from different prompt templates. The language model may be executed separately on each prompt, and the outputs of the different executions may be combined in order to generate an overall output at step 208.

In still another example, the prompt generation may be dynamic. For example, if a certain data type is present, then an algorithm for generating the prompt may cause additional metadata to be extracted or generated, and then added to one or more prompts.

In an embodiment, converting the relevant data into a prompt may include the following steps. The irrelevant data is removed. Then, from the relevant data, a number of data types are determined. Contextual data related to the electronic communication is identified. A prompt template including a number of prompt elements are retrieved. The prompt template may be retrieved from local storage or from a server. The relevant data is inserted into the prompt elements of the prompt according to the data types. In an embodiment, contextual data also may be added to the prompt.

The identity and purpose of data elements can be specified clearly in prompt directions when represented in a structured format. The structured format helps the set of elements included within a prompt to be scoped and referenced precisely. The structured format can improve the quality or consistency of the response to a complex prompt.

Element selection and inclusion in a prompt can be determined from the elements used to provide the desired assessment. For instance, in the case of an evaluation of internal consistency of authorship, the author display name, email address, and other author metadata might be included with the relevant guidelines in a prompt without any other data. The approach implicitly might be enacted for a complex prompt with the encoding schema providing sufficient clarity for the model to consider the correct elements in an evaluation. Content syntax, in an embodiment, may not be discounted as an encoding schema, but the use of explicitly labeled or structured data may provide superior results.

Encoding of a prompt may be consistent for improved results. Some language models may show improved performance with common data formatting standards that are encoded to some degree in the underlying networks of the language models, depending on training.

A non-standard encoding can be employed if clearly explained in set up prompting. One or more embodiments have employed JAVASCRIPT object notation (JSON) or extensible markup language (XML), and non-standard bracket tagging for certain elements to denote data, metadata, or relational, positional, or other characteristics or features of sub-elements within an element. Markup may perform better than positional encoding for most purposes. If a non-standard encoding is used, model results may be improved through consistency of format and representation.

In the case of a multimodal model, data may be included in a non-text format in some cases. However, doing so may impinge upon context size, cost, or other limitations using currently available models.

Encoded elements can be included in prompts to a language model using a guideline or set of guidelines to compare elements for consistency with authentic examples, as well as assess intent and evaluate against contextual data for signs of inconsistency. Guidelines are content to be included in a prompt along with data to be evaluated. Authentic examples need not be provided in the guidelines, as the guidelines may capture the evaluative methods and criteria (if not implicit) that contribute to an assessment of whether the subject of evaluation is consistent with authenticity.

The below examples of data comparison or other comparisons can be included in guidelines, but guidelines may include additional direction for how to evaluate the data, along with examples or descriptions of what might contribute to an appropriate result. The guidelines may be prompts or prompt segments that are included verbatim or parameters used in constructing a prompt and can be predetermined or optimized automatically. The guidelines may be obtained from a source determined to contribute to the evaluation.

Guidelines can also combine multiple evaluations. For example, a single guideline could include evaluations to be performed and be handed off to the model as a prompt, along with the entire data set to be evaluated. Multiple guidelines may also be combined.

Guidelines may be used to prompt the language model to evaluate consistency with authenticity for criteria. The criteria may include, but is not limited to, authorship, recipient, and user data compared for internal consistency, consistency with contextual data, consistency with content, consistency with activity, consistency with each other to determine internal email, hidden recipients, etc., as well as other criteria for suspicion or validation.

The criteria also may include recipient data compared with contextual data for internal consistency, consistency with content, consistency with intent, consistency with activity, signs of targeted attack, and other criteria for suspicion or validation. For example, as mentioned above, a prompt may be generated to cause the language model to output a proxy observer response as a criteria for evaluation. Stated differently, the language model may be commanded to evaluate how a human user would respond to the potentially suspicious electronic communication, and the resulting output evaluation is then used in the determinization of whether the electronic communication is malicious, deceptive, inauthentic, or untrustworthy.

Additionally, combinations of criteria may be used, possibly in combination with multiple executions of different prompts by different language models, and the resulting multiple outputs combined in order to generate the final prediction of legitimacy or illegitimacy of the electronic communication. The criteria also may include user data compared with recipient data for inclusion, third-party submission. The criteria also may include media data compared with content and contextual data for consistency between intent and presentation and other criteria for suspicion or validation.

The criteria also may include link text compared with uniform resource link (URL) and metadata for internal consistency, misleading labeling, dangerous links, suspicious labeling, link, or data, and other criteria for suspicion or validation. The criteria also may include attachment data compared for internal consistency, suspicious or misleading names, suspicious file types, suspicious content, name or file type consistency, or other criteria for suspicion or validation. The criteria also may include apparent intent compared with internal consistency, content, media data, attachment data, contextual data, link data, author data, recipient data, and other criteria for suspicion or validation.

The above evaluations may be combined or performed in parallel to the extent the evaluations are not dependent on earlier evaluations. The use of parallel prompting also may depend on the use of a natural language or an encoding schema, utilization of a model with specific domain competency to optimize prompt or response performance, or leveraging embedding comparisons.

Additional details regarding the prompting of the language model and examples of such prompts is now described. To achieve increased accuracy and consistency, a prompt set can supply a role or scenario to the language model. For example, the role may be expressed as a system message, such as “You are a methodical and insightful email analyst. You always evaluate step by step to determine authenticity of an email.”

System role prompts may work well for context or general guidelines, while user role prompts may be employed for immediate direction regarding a task. The system message is used in conjunction with a description of the specific objective, output formatting directions, and evaluation prompts. Providing the context serves more to condition the responses to fit objectives than to reach the objectives. However, there is interplay between the content of all prompts supplied for a given response, and small changes can affect significant performance shifts, especially in consistency of results.

In the case of large language models such as GPT3.5 and GPT4, a low temperature parameter generally performs well for one or more embodiments. A set temperature range of 2-3 may provide desirable results with better consistency than a higher temperature.

Example prompts are now provided. One example prompt states, “Links are represented in the format [link:{i:index,u:url,n:site name,r:reputation,i:industry}]DISPLAYED TEXT [/link]. Always check the displayed text and the surrounding context against the link data in case it may be a bogus link. A poor reputation should be mentioned but does not necessarily mean the link is deceptive. Discontinuity between displayed text and the link it represents indicates a higher chance of deception. Respond with a concise analysis of link credibility. Check this content for deceptive links: <content>”

Providing a schema for encoding is not always required, but commonly improves result accuracy and consistency. The response might be better provided in XML or JSON format, in which case, a syntactic template may be provided to standardize the result shape.

Another example prompt may be, “Hidden elements are represented in the format [hidden]HIDDEN TEXT[/hidden]. Always mention if there are hidden elements and point out if they seem pointless or if they contain content that might be used to obfuscate a malicious email. Provide an analysis of any hidden content found here: <content>”

The above example relies on the general ability of the model to make a determination based on provided format information and content. The example also benefits from a pre-processing step to correctly identify hidden elements.

A third example prompt is as follows: “System: You are an email analyst who looks for inconsistencies or signs of deception in an email. You don't jump to conclusions but warn of signs for concern. User: Does the sender email address seem like a plausible address match for the sender display name? Abbreviation and nicknames or other similarities contribute to a plausible match. It is a huge red flag if the sender display name includes an email address other than the actual email address. Please evaluate the consistency of sender name and email, then provide an analysis of any elements in the email body that might be suspicious: {email:{sender: {name:<sender name>, address:<sender email>}}, body: <content>}”

The third example again relies on the intuitive analytical ability of the model. More specific guidelines can yield better results in many cases, but strengths of the model can be leveraged to improve results. Complex prompts can be delivered together, or in some cases, provided in separate sub-prompts within a given prompt. Breaking up a complex prompt into sub-prompts can improve sequential (chain of thought) analysis or allow for better analysis for evaluations that do not already exhibit acceptable accuracy.

Returning to FIG. 2, step 206 includes executing the language model on the prompt. Executing the language model on the prompt may include issuing a command to the language model to consider the prompt or to execute the prompt specified at step 204. In a specific example, a user may use a widget to command the language model to analyze the electronic communication, in which case a server controller identifies the relevant and irrelevant data at step 202, converts the relevant data into the prompt at step 204, and executes the language model on the prompt at step 206.

In an embodiment, the language model may output, prior to outputting the prediction, a number of comparisons of the relevant data. In this case, the comparisons may be merged into the prediction output at step 208, below.

In an embodiment, step 206 may be performed multiple times. For example, multiple prompts may have been generated at step 204, in which case execution of the language model at step 206 is performed multiple times (at least one time on each prompt). In another example, the same prompt may be executed on multiple different language models. In this case, the outputs of the different language models may be combined at step 208, below.

Step 208 includes outputting, by the language model, a prediction whether the electronic communication is at least one of malicious, deceptive, inauthentic, and untrustworthy. Outputting may be performed by a number of different techniques.

For example, outputting may include displaying, to a user, an indication whether the electronic communication is malicious, deceptive, inauthentic, or untrustworthy. Outputting also may include, in combination with the indication of legitimacy or illegitimacy, a reason for why the electronic communication is deemed legitimate or illegitimate. Outputting also may include, possibly in combination with either of the above examples of outputting, returning, by the language model, a confidence valuation of an accuracy of the prediction (e.g., “high,” (as determined by the language model) “low,” (as determined by the language model), “95%,” etc.)

Thus, for example, assume that the output is that the electronic communication is malicious, deceptive, inauthentic, and untrustworthy. In this case, the method may include outputting, by the language model at step 208, an explanation for the prediction and also displaying, on a user device, the prediction and the explanation. The output also may indicate a “high” or “low” or a numerical confidence in the prediction.

Outputting also may include storing the output for further use, such as for fine-tuning the language model, as described further below. Alternatively, the further use may be to provide the output to another instance of hardware or software that further processes the electronic communication, as described with respect to the media manager, below.

In a specific example, outputting may include outputting the prediction to a media manager. The media manager may be software or application specific hardware which, when executed by a computer processor, performs a logical action with respect to the prediction, the electronic message, or both. For example, the media manager may permit, responsive to the prediction being that the electronic communication is not malicious, deceptive, inauthentic, or untrustworthy, the electronic communication to be delivered to a user device.

In another example, the media manager may display, responsive to the prediction being that the electronic communication is malicious, deceptive, inauthentic, or untrustworthy, the prediction to the user device. In this case, the media manager also may remediate, responsive to the prediction that the electronic communication is malicious, deceptive, inauthentic, or untrustworthy, the electronic communication.

Remediation may include locking the electronic communication to prevent the user from being able to click on links or to access file elements, at least without passing a warning challenge. Remediation may include blocking the sender's address in order to prevent further transmissions of future electronic communications from the sender. Remediation may include blocking a domain of the sender. Remediation may include providing the suspect electronic communication to an authority (e.g., an information technology department of an organization). Remediation may include deleting the electronic communication or routing the electronic communication to a junk folder.

Remediation also may include prompting the language model to generate messages to the user to educate the user or prompt the user to take some action. For example, the user may be advised to refrain from clicking on links contained in the electronic message. Remediation may include other actions.

The output also may be subject to evaluation. Evaluation of authenticity may be broken up into discrete directives, as provided in the guidelines. The process employed may be simple or quite complex. A simple prompt may be a prompt containing a directive to evaluate the authenticity of provided data (which would rely on a competency of the language model). A complex prompt may be a sequence of prompts providing step-by-step instructions with calls to external resources for validation, examples, comparison, etc. as a part of intermediate steps. At a review stage, multiple iterations of the preceding stages are processed. The evaluation process may also include filters, hallucination checks, and other restrictive processes in some cases.

Evaluation of embedding similarity can be employed to good effect in cases where semantic similarity is the purpose of the evaluation. Evaluation of embedding similarity does not necessarily employ natural language prompts, but may evaluate the model embeddings of elements directly. This kind of evaluation can benefit from fine-tuning to train sensitivity to the desired dimensions of similarity.

Evaluation results that feed into further evaluations may benefit from a post-processing step. The post-processing step may be performed prior to inclusion in the next prompt if the evaluation results are not presented in a form consistent with prompt directions or in keeping with the encoding format used in other data included in the prompt.

Results from comparisons can be tabulated and merged as appropriate to provide results in the desired format. The tabulation and merging process may depend on the nature of outputs to be merged and the desired return paradigm.

For instance, if building a scoring mechanism, the steps might include extracting value components from a result or result set and combining the results to produce a confidence score or multiple scores in grouped categories of responses. Language models can provide such values if prompted to do so, although it may be unclear what, in fact, contributes to the resulting answer. In many cases, language models do not yet seem as reliable as quantitative evaluation methods for this purpose, so it can be helpful to either prompt with a specific request for a value along with any other elements, or a Boolean result, then tabulate separately generated values.

For example, the language model may be prompted with a prompt such as, “How compelling is this analysis segment from 0-5. Please consider the logic, the details and the confidence expressed: [analysis]” or “please consider how well this analysis assesses the source material: {ANALYSIS: [analysis], SOURCE: [source content]}. Thus, the language model may be used to generate a quantitative evaluation of the accuracy of the model.

Another approach to quantifying analysis is to apply embedding comparison of the analysis with an embedding or set of embeddings of pre-existing analysis content with a known value. This technique may be used with responses that are tightly constrained or when combined with other techniques, such as removal of content specific to the instance prior to embedding or other methods of embedding normalization.

Results from separate prompts can be combined. Combination can be as simple as concatenation. Combination may be more complex, such as a prompt directing a language model to compile the result set. The latter case, the method of combination and the expected result format may be specified so that the result is compliant with recipient expectations. A summary of results may be generated through another prompt to a language model. Alternatively, a combination of methods may be used, and multiple steps employed to highlight analysis meta-characteristics or to provide other insight into either the results or the analysis.

Results or result sets can be returned in unmerged, merged, or other forms in a streaming fashion, asynchronously, or at a selected point or points for user display or use in other systems or additional steps. Results can be retained for use in the training or fine-tuning of other models. The data set can be improved through the employment of a feedback mechanism and quality ranking algorithm or similar system utilizing a language model for review.

In an embodiment, the method of FIG. 2 also may include step 210. Step 210 includes determining whether the language model should be improved by retraining in order to increase the accuracy of the output or the explanation for the output. The decision at step 210 may be performed automatically after an amount of time has passed (e.g., every month the language model is retrained). The decision at step 210 may be performed in response to a user overriding the result of the output at step 208 a number of times. For example, if the user determines that an electronic communication predicted to be malicious, deceptive, inauthentic, or untrustworthy is, instead, authentic more than a predetermined number of times, then a decision may be taken that the language model should be retrained at step 210. Likewise, if the user determines that an electronic communication predicted to be legitimate is, instead, malicious, deceptive, inauthentic, or untrustworthy more than a predetermined number of times, then a decision may be taken that the language model should be retrained at step 210.

Step 212 includes adding, to training data to generate updated training data, the content, the relevant data, the irrelevant data, the prompt, and the prediction. Adding the training data may include storing the information in a file in a data repository. The information may be stored in separate files, and accessed individually during training, or may be combined into a single file. For example, the additional training data may be converted into a vector data structure that is used as input when training the language model.

Step 214 includes retraining the language model on the updated training data to generate a fine-tuned language model. Training may be performed as described with respect to FIG. 1B. However, the training data includes at least the updated training data mentioned at step 212, above.

The method of FIG. 2 may be varied. For example, the method may include more steps or different steps. In an example, prior to step 200, the method also may include pre-processing the electronic communication prior to converting the relevant data into the prompt.

Pre-processing may include removing the irrelevant data and converting the relevant data into a predetermined data format suitable for inclusion in the prompt. Converting the relevant data into the predetermined data format may include sorting the relevant data into different prompt elements according to a number of types of data contained in the relevant data. In another embodiment, pre-processing may include extracting text from media content within the content. In yet another embodiment, pre-processing may include converting the electronic message from a received data type into another data type (e.g., converting a text email into a vector, or converting an image into text in the form of a caption automatically generated for the image by a vision language model). Other pre-processing steps may be performed.

Still other variations of the method of FIG. 2 are possible. For example, the method may be improved over ongoing use of one or more embodiments. Specifically, the embedded outputs and inputs may be retained in a vector space. Then, when a new electronic communication is received, the new electronic communication may be processed and the relevant data embedded. The new embedded vector may be compared to the saved embedded vector, such as by cosine similarity. A finding of authenticity, trustworthiness, truthfulness, benign nature, maliciousness, deceptiveness, inauthenticity, or untrustworthiness then may be performed without processing by the language model, thereby saving computing resources.

In another example, the evaluation of the legitimacy or illegitimacy of the electronic message may include an additional step of prompting the language model to generate a predicted response of a human user to the email. For example, the prompt to the language model may be “You are an unsophisticated human user. How would you respond to the electronic message?” Then, one or more embodiments may profile the response and not the content of the electronic message. In this manner, especially deceptively legitimate electronic messages may be detected and exposed.

Stated differently, similarity may be inferred through a process by which the content to be evaluated is employed to elicit a model-generated response used as a proxy for the intended observer reaction which can be embedded and subsequently compared or used in further prompt direction or decisions. This process can support a similarity of result or effect comparison that can be a useful component in determining legitimacy of the electronic communication. This variation of one or more embodiments may be powerful and specific with high meta-cognitive capability models, but can also be effective with less-capable models in certain contexts with prompting as described above.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3A, FIG. 3B, and FIG. 3C show an example data flow, in accordance with one or more embodiments. The data flow is shown in Exhibit A but may be broken up into multiple sub-figures in order to accommodate the entire data flow. The following example is for explanatory purposes only and not intended to limit the scope of one or more embodiments.

Initially, source data (300) is received. The source data (300) may be the electronic communication (102) described with respect to FIG. 1A.

Next, a server controller will pre-process data and elements (302). The data may be the content in the source data (300). The elements may be routing data (e.g., an internet protocol address), HTML codes, or other structural elements of the source data (300). In an example, an image or attachment recognition is performed, including a classification and description of the source data (300).

The data and elements (302) may be supplemented by additional data (304). The additional data (304) may be metadata extracted from the source data (300) or related to the source data (300). Other additional data (304) may be added to the pre-process data and elements (302), such as described with respect to FIG. 3B and FIG. 3C.

Next, the server controller will encode data and elements (306). Specifically, the server controller will encode contextually relevant data and elements for evaluation by the language model. The server controller also may remove irrelevant data and elements. Encoding is the process of converting data in one type of data structure into a vector data structure. Vector data structures are described with respect to FIG. 1B.

Attention is now turned to FIG. 3B, following connector (390) in both FIG. 3A and FIG. 3B. From step of encode data and elements (306), a number of sets of encoded data are generated. Thus, the encoded data and elements (306) include encoded content (308), encoded media data (310), encoded attachment data (312) (i.e., data related to attachments to the electronic communication), encoded contextual data (314) (e.g., data that describes a context in which the electronic communication was received), and any encoded additional data (316) (e.g., time stamps, sender identity, etc.).

The various forms of encoded data described above are provided to a language model (318). One or more evaluation guidelines (320) may be used to convert the various encoded data into one or more prompts (322). The language model (318) may be executed on the prompts (322) to generate an output (324) and an explanation (326), as described with respect to FIG. 2. Thus, the language model (318) may evaluate element combinations according to guidelines by prompting language model (318). The process may be distributed across multiple prompts for precise or scoped results or combined, depending on language model characteristics and application specifications.

In an embodiment, the prompts (322), the output (324), and the explanation (326) may be provided to a training process (328). The training process (328) may train or retrain the language model (318) by using prompt, output, or explanation feedback as additional training data for fine-tuning the language model (318).

The output of the language model (318) may be routed to different processes. For example, as indicated by connector (392) in both FIG. 3A and FIG. 3B, the prompts (322), the output (324), and the explanation (326) from a prior use of the language model (318) according to one or more embodiments may be provided as the additional data (304) during the pre-processing of data and elements (302). In another example, as indicated by connector (394) in both FIG. 3B and FIG. 3C, the output (324) and the explanation (326) (and possibly the prompts (322)) may be output as a returned result (330).

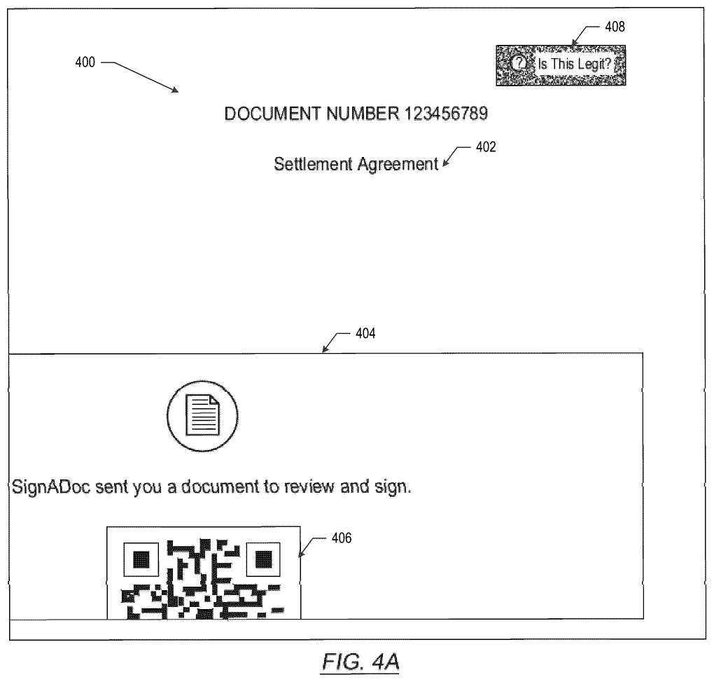

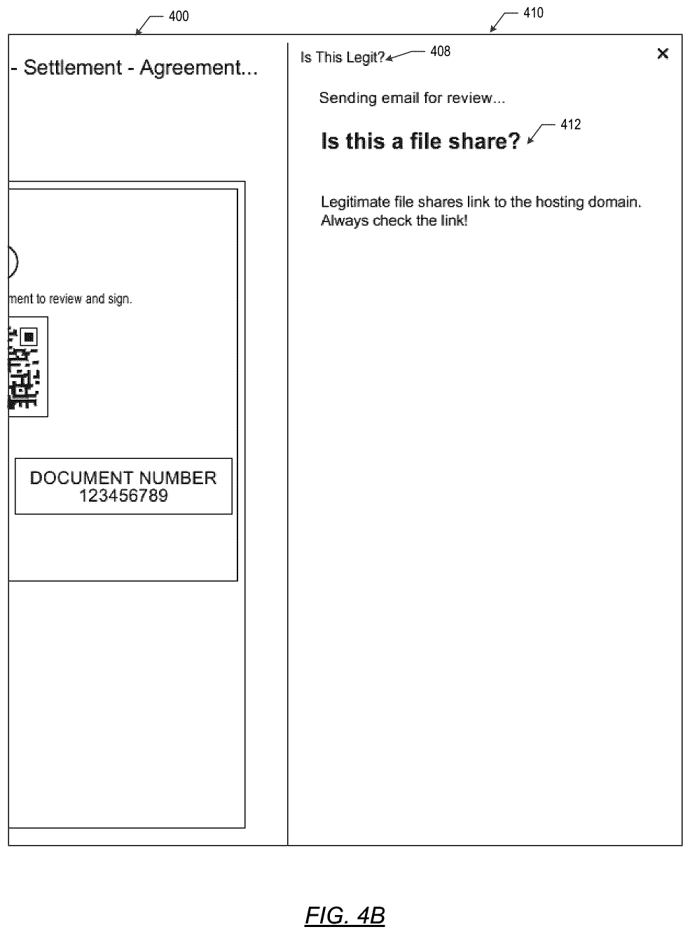

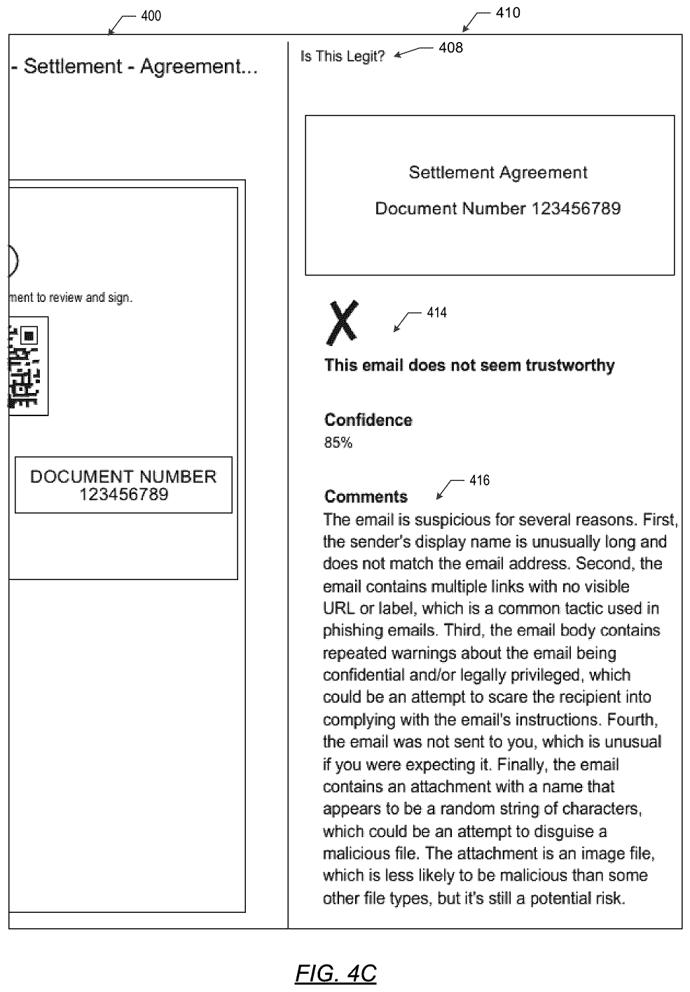

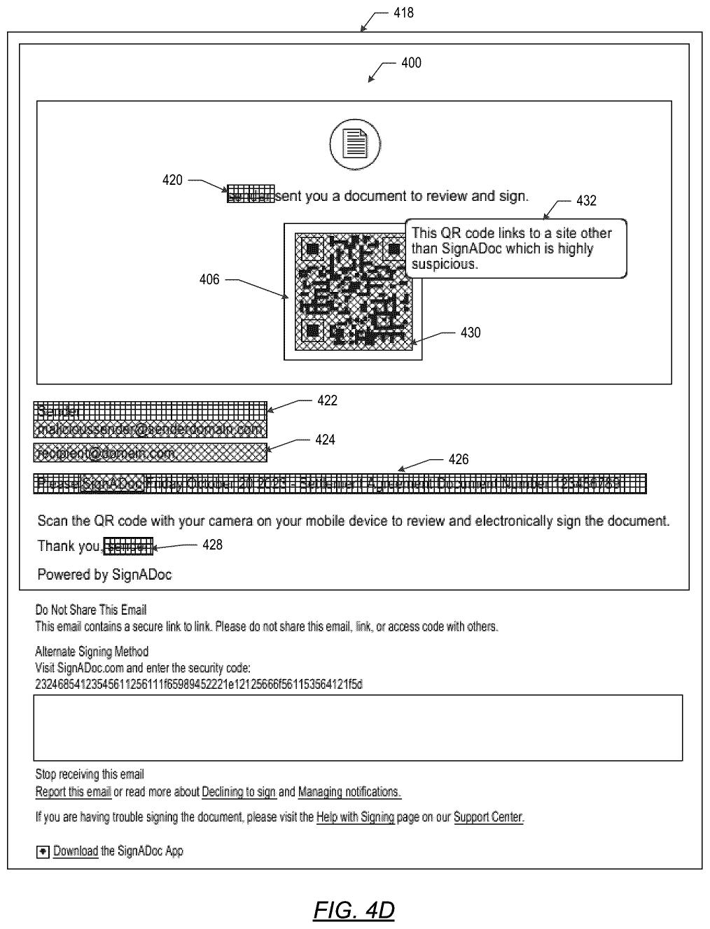

Referring to FIG. 3C, optionally, the returned result (330) may be subject to a post-process (332). The post-process (332) may merge the returned result (330) from different prompts, tabulate information or data where appropriate, etc. The post-process (332) may be subjected to format guidelines (334) that, when applied, formats the returned result (330) in a desired manner (e.g., a formatted output as shown in FIG. 4C). After the post-process (332) is complete, the output (334) is generated. The output (334) then may be used in a variety of manners, such as displaying the output (334) to a user, providing the output (334) to another process (e.g., the media manager described above), stored, etc.

Note that the returned result (330) may be provided back to the evaluation guidelines (320) shown in FIG. 3B, as indicated by connector (396) in both FIG. 3C and FIG. 3B. In other words, the returned result (330) may be evaluated for appropriateness by the language model (318), or the returned result (330) may be added to the evaluation guidelines (320).

Note also that the returned result (330) may be provided back to the additional data (304) shown in FIG. 3A, as indicated by connector (398) in both FIG. 3C and FIG. 3A. In other words, the returned result (330) may be added as additional data (304) for further pre-processing, while pre-processing data and elements (302) with respect to future electronic communications are received and processed as described herein.

One or more embodiments have been tested using large language models such as “GPT-3.5 Turbo” and “GPT-4” with different context window sizes, along with experimentation with the assignment of jobs based on complexity and performance as measured by rate of result compliance with a desired result. GPT-3.5 Turbo can produce similar results to GPT-4 in many cases, but tends to become overloaded with complex prompts, and sometimes misrepresents the results of simple comparisons. These drawbacks can be mitigated to some degree through the separation of prompts and responses or by limiting the scope or complexity of a given prompt and response.

However, an increased number of discrete calls to the GPT-3.5 Turbo model often accretes to overall result in latency or costs greater than that of GPT-4 using combined prompts to achieve a similar desired result. Beyond these issues, there are aspects of natural language that might lead to insight regarding authenticity in a larger context but might be absent or overlooked when separating evaluation tasks into separate prompts and responses. Including as much relevant content as possible and providing prompts with structured or sequential instructions can improve detection in such a scenario and increase the specificity, accuracy, and consistency of the results.

The nature of a data source and the use case can inform alternative implementations or flexible implementations. Differing data sources may include different elements relevant to evaluation, may benefit from different evaluation logic, and may be obtained in differing contexts or in different data formats. In addition, the dimension of authenticity being evaluated may differ from use case to use case or be a set of evaluations or composite evaluation(s) across dimensions.

For example, the question of image authenticity in a digital form can be nebulous, with the definition of authenticity unclear without specification. In one case, specification may involve the determination of authenticity as a licensed use of an image of known authorship and provenance in a given example. In this case, elements such as identity of authorship, ownership, data pertaining to related parties, licensing terms or data, venue of use, date and time data, image data and metadata, etc., may be relevant to an evaluation of whether a use constitutes a licensed use. In this same case, a different dimension of authenticity might be examined with an evaluation of whether the image is derivative, an altered version, other use of the original image in question, or an evaluation of whether the use falls within those provided for in a license. The evaluation can benefit from the embodiment of evaluation logic in guidelines used in the evaluation, along with a method or methods determined to be effective at extracting or producing relevant criteria from data provided in the subject source, or additional relevant data sources for use in prompting.

FIG. 4A, FIG. 4B, FIG. 4C, and FIG. 4D show screenshots of one or more embodiments in use. FIG. 4A shows a screenshot of an electronic communication (400). The electronic communication (400) is designed to prompt a user to sign a document. Thus, for example, the electronic communication (400) includes an authentic-appearing document number (402), a title (404) that is appropriate to the user's line of work, and a document signing link or quick response (QR) code (406).

However, the user device that displays the electronic communication (400) also shows a widget (408). The widget (408), when actuated, triggers the method of FIG. 2 and thereby uses a language model as described above to evaluate whether the electronic communication (400) is authentic (i.e., “legit”) or malicious, deceptive, inauthentic, or untrustworthy.

FIG. 4B shows an evaluation screen (410). The electronic communication (400) is also shown next to the evaluation screen (410). The evaluation screen (410) is displayed after the user selects the widget (408). The evaluation screen (410) indicates that the email is being sent to a server for application of the method of FIG. 2. In the meantime, the evaluation screen shows an educational message (412) intended to educate the user during processing.

FIG. 4C shows a screenshot of an example prediction and explanation in the evaluation screen (410). The electronic communication (400) is also shown next to the evaluation screen (410). The prediction (414) is shown as three elements to clearly demark the electronic communication (400) as being untrustworthy. The three elements include an “X,” the message “this email does not seem trustworthy,” and the confidence score of “85%.” The confidence indicates the predicted probability that the electronic communication (400) is untrustworthy (and therefore illegitimate and possibly malicious, deceptive or inauthentic).

In addition, FIG. 4C shows an explanation (416) for the prediction (414). The explanation (416) is shown as text in the comments section of the evaluation screen (410). As can be seen, the language model analyzed specific characteristics of the electronic communication (400) that point to the likelihood that the electronic communication (400) is deceptively legitimate (i.e., is untrustworthy and illegitimate).

FIG. 4D shows a screenshot (418) of a different technique for displaying a prediction and explanation. The prediction may be displayed in line with the electronic communication (400), by way of highlighting or overlay as shown at line (420), line (422), line (424), line (426), line (428), line (430), or overlay (432) over the QR code (406) shown.

Additionally, comments either overlaid or shown inline on the screen. For example, comment (432) is added to the portion of the electronic communication (400) that includes the QR code (406). The comment (432) is added as part of the output process described above with respect to FIG. 2, or FIG. 3A, FIG. 3B, and FIG. 3C. The comment (432) informs the user that the QR code (406) links to a site other than SignADoc (which in this example is a legitimate vendor), and thus the QR code (406) is highly suspicious. In this manner, the user may receive both the prediction of untrustworthiness and the explanation for why the electronic communication (400) likely is an untrustworthy, deceptively legitimate communication.

Thus, one or more embodiments provide for a method. The method includes receiving an electronic communication including content. The method also includes converting the content into a prompt for a language model and providing the prompt to the language model. The method also includes outputting, by the language model, a prediction whether the electronic communication is malicious, deceptive, inauthentic, or untrustworthy.

The method described above may be varied. For example, the method also may include pre-processing the electronic communication prior to converting the content into the prompt. The method also may include outputting, by the language model, an explanation for the prediction. The method also may include remediating the electronic communication, responsive to the prediction that the electronic communication is malicious, deceptive, inauthentic, or untrustworthy.

One or more embodiments also contemplate a system that implements the method described above. The system includes a server controller which, when executed by a processor, performs the method. The system also may include a training controller which, when executed by the processor, trains the language model as described above.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving an electronic communication comprising content;
identifying, in the content, relevant data comprising a first portion of the content predetermined to be relevant to an evaluation of authenticity of the electronic communication and irrelevant data comprising a second portion of the content predetermined to be irrelevant to the evaluation;
converting the relevant data into a prompt for a language model;
executing the language model on the prompt; and
outputting, by the language model, a prediction whether the electronic communication is at least one of malicious, deceptive, inauthentic, and untrustworthy.

2. The method of claim 1, further comprising:
outputting, by the language model, an explanation for the prediction.

3. The method of claim 1, further comprising:
outputting, by the language model, an explanation for the prediction; and
returning, by the language model, a confidence valuation of an accuracy of the prediction.

4. The method of claim 1, wherein the prediction is that the electronic communication is malicious, and wherein the method further comprises:
outputting, by the language model, an explanation for the prediction; and
displaying, on a user device, the prediction and the explanation.

5. The method of claim 1, wherein outputting comprises outputting the prediction to a media manager.

6. The method of claim 5, wherein the method further comprises the media manager performing an action comprising one of:
permitting, responsive to the prediction being that the electronic communication is not malicious, the electronic communication to be delivered to a user device; and
displaying, responsive to the prediction being that the electronic communication is malicious, the prediction to the user device.

7. The method of claim 1, further comprising:
remediating, responsive to the prediction that the electronic communication is malicious, the electronic communication.

8. The method of claim 1, wherein the content comprises a combination of text, an image, and hypertext markup language (HTML) data, and wherein the relevant data comprises the text and the image.

9. The method of claim 8, wherein:
the text further comprises unimportant text determined, by the language model, to be semantically unimportant; and
the irrelevant data comprises the HTML data and the unimportant text.

10. The method of claim 1, wherein the prediction is that the electronic communication is malicious, and wherein the method further comprises:
outputting, together with the prediction, a reason expressed in human readable language why the electronic communication is malicious and a suggested course of action for a user to take.

11. The method of claim 1, wherein receiving the electronic communication comprises receiving at least one of an email, a text, an instant message, and a social media post, and wherein identifying, converting, and outputting are performed automatically upon receipt of the electronic communication.

12. The method of claim 1, further comprising:
pre-processing the electronic communication prior to converting the relevant data into the prompt.

13. The method of claim 12, wherein pre-processing comprises:
removing the irrelevant data; and
converting the relevant data into a predetermined data format suitable for inclusion in the prompt.

14. The method of claim 13, wherein converting the relevant data into the predetermined data format comprises sorting the relevant data into different prompt elements according to a plurality of types of data contained in the relevant data.

15. The method of claim 1, further comprising:
generating an additional prompt instructing the language model to predict a reaction of a human user to the electronic communication; and
executing the language model on the additional prompt to generate a predicted reaction; and
outputting the prediction at least in part based on the predicted reaction.

16. The method of claim 1, further comprising:
removing the irrelevant data;
determining, from the relevant data, a plurality of data types;
identifying contextual data related to the electronic communication;
retrieving a prompt template comprising a plurality of prompt elements;
inserting the relevant data into the plurality of prompt elements of the prompt according to the plurality of data types; and
adding the contextual data to the prompt.

17. The method of claim 1, further comprising:
outputting, by the language model and prior to outputting the prediction, a plurality of comparisons of the relevant data; and
merging the plurality of comparisons into the prediction.

18. The method of claim 1, wherein converting the relevant data into the prompt comprises converting the relevant data into a plurality of prompts, wherein executing the language model on the prompt comprises executing the language model separately on the plurality of prompts; and wherein the method further comprises:
combining a plurality of outputs, corresponding to the plurality of prompts, of the language model into the prediction.

19. The method of claim 1, further comprising:
adding, to training data to generate updated training data, the content, the relevant data, the irrelevant data, the prompt, and the prediction; and
retraining the language model on the updated training data to generate a fine-tuned language model.

20. A system comprising:
a computer processor;
a data repository in communication with the computer processor and storing:
an electronic communication comprising content, wherein the content comprises relevant data comprising a first portion of the content predetermined to be relevant to an evaluation of authenticity of the electronic communication and irrelevant data comprising a second portion of the content predetermined to be irrelevant to the evaluation,
a prompt for a language model, and
a prediction whether the electronic communication is at least one of malicious, deceptive, and inauthentic;
a server controller which, when executed by the computer processor, performs a computer-implemented method comprising:
receiving the electronic communication,
identifying, in the content, the relevant data and the irrelevant data,
converting the relevant data into a prompt for a language model;
executing the language model on the prompt; and
outputting, by the language model, the prediction.
